(19) United States
(12) Patent Application Publication
(10) Pub. No.: US 2006/0237664 A1
(43) Pub. Date: Oct. 26, 2006

(54) Feedback control system

(75) Inventor: James Kane, Needham Heights, MA (US)

Correspondence Address: TOWNSEND & BANTA;c/o PORTFOLIO IP, PO BOX 52050, MINNEAPOLIS, MN, 55402, US

(73) Assignee: Polestar Technologies, Inc.

(21) Appl. No.: 11/113,464

(22) Filed: Apr. 25, 2005

(51) Int. Cl. G01J 1/58

(52) U.S. Cl. 250/458.1

(57) ABSTRACT

An optical sensor feedback control device is provided comprising a luminescent sensing film, an optical processor adjacent the sensing film capable of sinusoidally photoexciting the luminescent sensing film and detecting the luminescent emission resulting therefrom, and a control means in communication with the optical processor for control of the magnitude of the photoexcitation, to receive information regarding the luminescent emission resulting therefrom, and generation of an electrical signal for determination of the magnitude and phase shift of the luminescence relative to the photoexcitation. The device of the present invention further has an optical processor positioning means in communication with the control means and the optical processor for adjusting the physical position of the optical processor and/or light source in relation to the sensing film based on data received from the control means. In addition, a method of feedback control of an optical sensor is provided.

### FIELD OF THE INVENTION

An optical chemical sensor feedback control device for controlling optical sensing systems utilizing phase-sensitive fluorescence lifetime measurement in the detection process is provided. This optical chemical sensor feedback control device adjusts and/or replaces sensors in a system as needed, via an optical processor, optical processor positioning means and a control means. In addition, a method of feedback control of an optical sensor is provided.

### BACKGROUND OF THE INVENTION

Optical chemical sensors have been developed for monitoring the concentration of a variety of chemical constituents, including molecular O₂, pH and carbon dioxide. These sensors have significant advantages over the more traditional electrochemical sensors, such as electrical isolation for the environment measured, small size, immunity to calibration drift arising from sensing membrane fouling and compatibility with non-contacting measurements. Applications include, for example, monitoring conditions within fermentation and cell culture bioreactors, and ultra-pure water, such as is used in the fabrication of semiconductors.

Although such optical chemical sensors are extremely effective in monitoring various concentrations in a variety of situations, frequent replacement or service of the sensors is necessary. Replacement or service of such sensors can be very time consuming and expensive as, frequently, or portion, or even the entire, system/process must be shut down to enable replacement or service of the sensors. Moreover, depending on the nature of the system under investigation, replacement or service of the sensor may be impossible, and failure of the sensor may lead to a complete overhaul of the system, such as emptying the system of all components, cleaning the entire system thoroughly, restarting the system from scratch.

In view of the disadvantages associated with the conventional use of optical chemical sensors in environments such as fermentation and cell culture bioreactors, it is an object of the present invention to provide a optical sensor feedback control device which can monitor optical chemical sensors in a system, and adjust/replace the optical chemical sensors as needed while eliminating and/or minimizing disturbance to the environment monitored.

It is a another object of the present invention to provide a method of feedback control of an optical sensor, wherein the optical sensor is utilized, monitored, and replaced/adjusted as needed.

### SUMMARY OF THE INVENTION

In order to achieve the objects of the present invention as described above, the present inventor earnestly endeavored to provide an optical chemical sensor feedback control device and method of feedback control of an optical sensor. In doing so, the present inventor discovered an optical chemical sensor feedback control device that can be used for controlling/monitoring the status of a sensing element or portion of the material or sensing membrane. It was unexpectedly discovered that, when using the device of the present invention, any sensing materials can be controlled/monitored, such as O₂ sensors, pH sensors, glucose sensors, temperature sensors, carbon dioxide, pressure, etc.

In particular, in a first embodiment of the present invention, an optical sensor feedback control device is provided comprising:
(a) a luminescent sensing film;
(b) an optical processor adjacent said sensing film comprising:
   (i) a light source for luminescent photoexcitation of said sensing film,
   (ii) a photodetector for detection of luminescent emission of said sensing film,
(c) a control means in communication with the optical processor, such that the control means controls the magnitude of the sinusoidal photoexcitation of the sensing film, receives parameter sensitive luminescent emission signals at the photodetector, and which generates an electrical signal that is used to determine magnitude and phase shift of the luminescence relative to the excitation.
(d) an optical processor positioning means in communication with the control means and the optical processor, said optical processor control means adjusting the physical position of the optical processor in relation to the sensing film based on data received from the control means.

In a second embodiment of the present invention, the device of the first embodiment above is provided, wherein the luminescent film comprises a polymeric substrate, said polymeric substrate comprising a polymeric material and a luminescent indicating composition.

In a third embodiment of the present invention, the device of the second embodiment above is provided, wherein the polymeric substrate is a silicone, polyurethane, polymethylmethacrylate, acrylics, polycarbonates or a sol gel.

In a fourth embodiment of the present invention, the device of the second embodiment above is provided, wherein the luminescent indicating composition is an organometallic complex.

In a fifth embodiment of the present invention, the device of the fourth embodiment above is provided, wherein the organometallic complex is selected from the group consisting of organometallic transition metal complexes and lanthanide series complexes.

In a sixth embodiment of the present invention, the device of the first embodiment above is provided, wherein the light source is an LED, organic LED, incandescent bulb, laser, flashlamp, or an electroluminescent device.

In a seventh embodiment of the present invention, the device of the first embodiment above is provided, wherein the light source further comprises a fiber optic adjacent the light source, such that light may be transmitted via the fiber optic for luminescent photoexcitation of said sensing film.

In an eighth embodiment of the present invention, the device of the first embodiment above is provided, wherein the photodetector is a silicon photodiode, an avalanche photodiode or photomultiplier tube.

In an ninth embodiment of the present invention, the device of the first embodiment above is provided, wherein the control means is an analog feedback loop.

In a tenth embodiment of the present invention, the device of the first embodiment above is provided, wherein the control means is a digital microprocessor.

In an eleventh embodiment of the present invention, the device of the tenth embodiment above is provided, wherein said digital microprocessor utilizes digital phase lock loop technique for extracting signal magnitude and phase shift information.

In an twelfth embodiment of the present invention, the device of the first embodiment above is provided, wherein the optical processor positioning means comprises:
a control means communication link in communication with the control means; and
an optical processor position adjustment device in communication with the control means communication link.

In a thirteenth embodiment of the present invention, the device of the twelfth embodiment above is provided, wherein the optical processor position adjustment device is a stepper motor, a pneumatic piston, a hydraulically driven piston, an electric motor or a mechanical motor, or a combination of the above.

In a fourteenth embodiment of the present invention, a method of feedback control of an optical sensor is provided comprising:
(a) sinusoidally photoexciting a luminescent sensing film positioned adjacent a testing environment to create a luminescent emission within said film;
(b) detecting said luminescent emission and convert said luminescent emission signal to an electrical signal via a photodetector,
(c) determining the magnitude of the electrical signal via a control means;
(d) determining the phase of the electrical signal via a phase detector;
(e) controlling the magnitude of the sinusoidal photoexcitation of the sensing film based on the magnitude of the electrical signal determined by the control means; and
(f) converting the phase of the electrical signal to a parameter of interest value.

In a fifteenth embodiment of the present invention, the method of the fourteenth embodiment above is provided, wherein the sinusoidal excitement of the sensing film comprises photoexciting the luminescent sensing film using an LED, organic LED, incandescent bulb, flashlamp, or electroluminescent display.

In a sixteenth embodiment of the present invention, the method of the fourteenth embodiment above is provided, wherein the sinusoidal excitement of the sensing film comprises photoexciting the luminescent sensing film using an LED, organic LED, incandescent bulb, flashlamp, or electroluminescent display via a fiber optic.

In a seventeenth embodiment of the present invention, the method of the fourteenth embodiment above is provided, wherein the luminescent emission is converted to an electrical signal via a silicon photodiode, an avalanche photodiode or a photomultiplier tube.

In an eighteenth embodiment of the present invention, the method of the fourteenth embodiment above is provided, wherein determination of the magnitude of the electrical signal via the control means is carried out using analog or digital methods.

### BRIEF DESCRIPTION OF THE DRAWINGS

FIG. 1 is a perspective view of the optical processor positioning means of the first, twelfth and thirteenth embodiments of the present invention, illustrating the use of a linear positioner design as the optical processor positioning means. In particular, in this example, a lead screw is used to translate rotary motion into linear motion by mounting the optical processor to the lead screw via a bearing such that the optical processor can be moved along the length of the sensing film by rotating the lead screw with the stepper motor.

FIG. 2 is a perspective view of the optical processor positioning means of the first, seventh, twelfth and thirteenth embodiments of the present invention, illustrating the use of a rotational positioning motion means to reposition the optical processor's fiber optic element with respect to the sensing film being utilized, such that the area of illumination of the sensing film can be changed over time. The fiber optic is an example of a conduit over which optical excitation and fluorescent emission signals can be communicated.

FIG. 3 is perspective view of the optical processor positioning means of the first, seventh, eleventh and twelfth embodiments of the present invention, illustrating the use of a rotational positioning motion in conjunction with a cylindrical probe that houses a luminescent sensing film. The probe includes a cylindrical inner body element positioned within a cylindrical outer body to which is attached the fluorescent sensing film. A fiber optic element is attached to the inner body in such a way as to allow a new area of the sensing film to be illuminated by rotating the inner body within the outer body element.

FIG. 4 is a flow diagram illustrating the method of feedback control of an optical sensor of the thirteenth through eighteenth embodiments of the present invention.

### DETAILED DESCRIPTION OF THE INVENTION

Many feedback control systems utilize fluorescence lifetime-based optical sensors to monitor the concentration of a variety of chemical constituents, such as molecular O₂, pH and carbon dioxide. These optical sensors contain sensing membrane(s) which need replacement and/or servicing on a regular basis. The optical sensor feedback control device 1 of the present invention allows a user thereof to either exchange the sensing membrane with a fresh sensing film 3 or, alternatively, move the optical interrogation system (referred to herein as the optical processor 5) to a section of the sensing membrane that has not been adversely affected by overuse or environmental causes, such as excessive photobleaching.

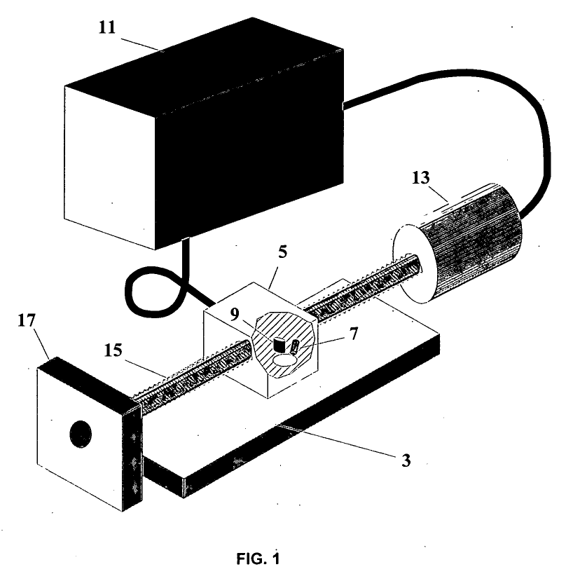

In particular, as illustrated in FIGS. 1-4, the optical sensor feedback control device 1 of the present invention uses measurements of signal intensity in conjunction with phase-shift detection as a means of monitoring the parameter of interest and the status of the sensing membrane (sensing film 1). This is achieved by interfacing the optical processor 5 with a computer-controlled positioning system 19 to enable automatic relocation of the optical processor 5 (having a light source to photoexcite the sensing membrane 3 and a photodetector 9 to measure the luminescent emission produced thereby) to a fresh (active) area of the sensing membrane in response to low signal levels.

For example, as shown in FIG. 1, the optical sensor feedback control device 1 comprises a luminescent sensing film 3, and an optical processor 5 positioned adjacent the luminescent sensing film 3, the optical processor 5 having a light source 7 capable of photoexciting the sensing film 3 and a photodetector 9 for detecting the luminescent emission of the sensing film 3. The device 1 further comprises a control means 11 in communication with the optical processor 5, which controls the magnitude of the photoexcitation of the sensing film 3, receives parameter sensitive luminescent emission signals via the photodetector 9, and generates an electrical signal based on same to determine the magnitude and phase shift of the luminescence of the sensing film 3 relative to the photoexcitation of the sensing film 3 by the optical processor 5.

The device 1 further comprises an optical processor positioning means 13 in communication with the control means 11 and the optical processor 5. The control means 11, when determining that the sensing membrane 3 is no longer performing satisfactorily via feedback provided by either direct measurements of fluorescence signal magnitude during sinusoidal excitation of the sensing chemistry or by electronically controlled corrections to the amplitude of the fluorescence excitation source to maintain fixed amplitudes of recovered fluorescence signals, causes the optical processor positioning means 13 to adjust the position of the optical processor 5 relative to the luminescent sensing film 3.

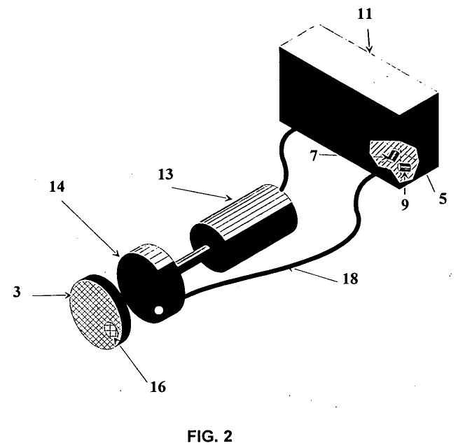

Alternatively, as illustrated in FIG. 2, an optical conduit, such as an fiber optic 17, may be used to limit the area of sensing film 3 under examination, by repositioning the fiber optic 17 by means of a fiber optic positioner 13 in conjunction with optical processor positioning means 19. This method may also be employed in a linear positioning means, such as that used in the device 1 shown in FIG. 1, as moving a fiber optic attached to the lead screw in FIG. 1 would reposition the light source 7 relative to the sensing film 3.

In particular, as illustrated in FIG. 2, the optical processor positioning means 13 may be in the form of a rotational positioning device such as a stepper motor that can be manipulated/commanded by the control means 11 to move a fiber optic light source 7 via a fiber optic positioner 13 relative to a fixed luminescent sensing film 3 when the control means 11 determines that the effective lifetime of the area of illumination 15 of the luminescent sensing film 3 has expired. Thus, when the area of illumination 15 of the luminescent film 3 is no longer performing optimally, a new, unused, active portion of the luminescent sensing film 3 is exposed to the light source 7 of the optical processor 5.

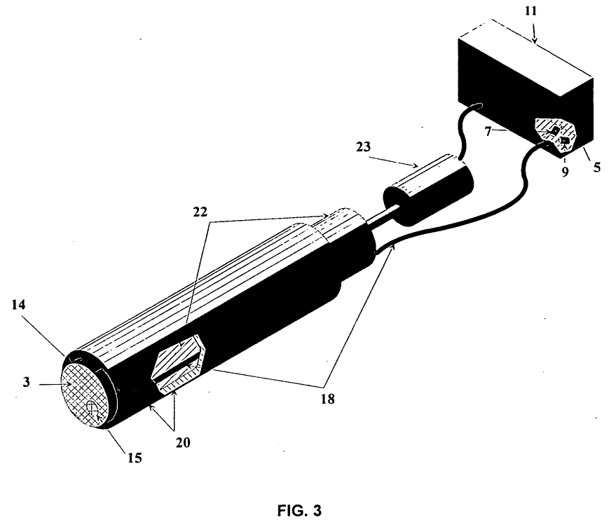

In a further embodiment, as disclosed in FIG. 3, herein, a probe design is provided, wherein a luminescent sensing film 13 is attached to the end of a probe outer body 17, designed to allow the insertion of a probe inner member 19 which holds the end of a fiber optic cable 21 at the distal end of the probe outer body 17, thus enabling the communication of optical signals between an optical processor 5 and the sensing film 13. The portion of the sensing film being observed 15 is determined by the position of the fiber optic 21 which can be changed by rotating the probe inner body 19 with respect to the outer body 20 using the optical processor positioning means 23.

In addition, a method of feedback control of an optical sensor is provided by the present invention, comprising the steps of:
(a) sinusoidally photoexciting a luminescent sensing film positioned adjacent a testing environment to create a luminescent emission within said film;
(b) detecting said luminescent emission and convert said luminescent emission signal to an electrical signal via a photodetector,
(c) determining the magnitude of the electrical signal via a control means;
(d) determining the phase of the electrical signal via a phase detector;
(e) controlling the magnitude of the sinusoidal photoexcitation of the sensing film based on the magnitude of the electrical signal determined by the control means; and
(f) converting the phase of the electrical signal to a parameter of interest value.

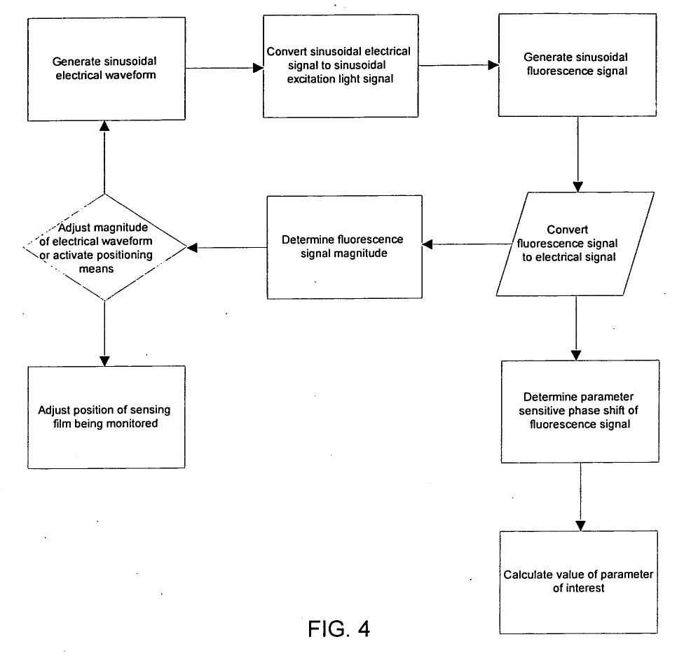

The method as described above, and as illustrated in FIG. 4 herein, involves sinusoidal excitation of a fluorescent sensing film, thus generating a sinusoidally modulated fluorescence of the same frequency but phase-shifted relative to the light source by virtue of the sensing film's fluorescent indicator molecule's metastable excited state. These fluorescence phase-shifts are solely a function of the lifetime of the fluorescence and the modulation frequency used to excite the chemistry (i.e., the fluorescence indicator). This feature allows quantification of the parameter of interest based on measurements of the fluorescence lifetime of the indicator system, rather than measurements of the fluorescence intensity, which can vary over time as a result of the indicator photobleaching, optical misalignment, detector gain changes and/or variations in the refractive index or turbidity of the sample media being probed.

As the light source for photoexciting the luminescent sensing film 3, an LED, organic LED, incandescent bulb, flashlamp, or electroluminescent display may be used. The luminescent emission caused by the photoexcitation of the luminescent sensing film 3 is converted to an electrical signal via a silicon photodiode, an avalanche photodiode or a photomultiplier tube. The method of the present invention further involves determining the magnitude of the electrical signal via the control means 11, by using either analog or digital methods.

Furthermore, the light source may photoexcite the luminescent sensing film via a fiber optic, as illustrated in FIGS. 2 and 3 herein. The use of a fiber optic allows the area of photoexcitation to be limited and specifically defined, and allows the light source to be located remotely from the sensing film.

The use of the optical sensor feedback control devices shown, as described above and as illustrated in FIGS. 1-3, and the method, as described above and as illustrated in FIG. 4 herein, allow highly accurate control/monitoring of the status of a sensing element or portion of the material or sensing membrane for various sensing materials. Sensing materials applicable include, but are not limited to, O₂ sensors, pH sensors, glucose sensors, temperature sensors, carbon dioxide sensors, and pressure sensors.

What is claimed is:

1. An optical sensor feedback control device comprising:
(a) a luminescent sensing film;
(b) an optical processor adjacent said sensing film comprising:
(i) a light source for luminescent photoexcitation of said sensing film,
(ii) a photodetector for detection of lumiscent emission of said sensing film;
(c) a control means in communication with the optical processor, such that the control means controls the magnitude of the sinusoidal photoexcitation of the sensing film, receives parameter sensitive luminescent emission signals at the photodetector, and which generates an electrical signal that is used to determine magnitude and phase shift of the luminescence relative to the excitation.
(d) an optical processor positioning means in communication with the control means and the optical processor, said optical processor control means adjusting the physical position of the optical processor in relation to the sensing film based on data received from the control means.

2. The optical sensor feedback control device of claim 1, wherein the luminescent film comprises a polymeric substrate, said polymeric substrate comprising a polymeric material and a luminescent indicating composition.

3. The optical sensor feedback control device of claim 2, where in the polymeric substrate is a silicone, polyurethane, polycarbonate, nylon, polystyrene, polyester, polyolefin, polyacrylamide, cellulose, epoxy, vinyl, natural rubber or a sol gel.

4. The optical sensor feedback control device of claim 2, wherein the luminescent indicating composition is selected from the group comprising fluorescein and fluorescein derivatives such as carboxyfluorescein, rhodamine, seminaphtharhodamine, seminaphthafluorescein, hydroxyprene trisulfonic acid, organometallic complexes and “tethered-pair” indicators as are described in U.S. Pat. No. 5,037,615.

5. The optical sensor feedback control device of claim 4, wherein the organometallic complex is one selected from the group consisting of organometallic transition metal complexes including complexes of ruthenium, osmium, iridium, rhodium rhenium and chromium, and lanthanide series complexes including complexes of terbium, europium, and erbium.

6. The optical sensor feedback control device of claim 1, wherein the light source is an LED, organic LED, incandescent bulb, laser, flashlamp, and/or electroluminescent device.

7. The optical sensor feedback control device of claim 1, wherein the light source is an LED, organic LED, incandescent bulb, laser, flashlamp, and/or electroluminescent device via an optical communication means.

8. The optical sensor feedback control device of claim 7, wherein the optical communication means is a fiber optic.

9. The optical sensor feedback control device of claim 1, wherein the photodetector is a silicon photodiode, an avalanche photodiode, or photomultiplier tube.

10. The optical sensor feedback control device of claim 1, wherein the control means is an analog feedback loop.

11. The optical sensor feedback control device of claim 1, wherein the control means is a digital microprocessor.

12. The optical sensor feedback control device of claim 11, wherein said digital microprocessor utilizes digital phase lock loop technique for extracting signal magnitude and phase shift information.

13. The optical sensor feedback control device of claim 1, wherein the optical processor positioning means comprises:
a control means communication link in communication with the control means; and
an optical processor position adjustment device in communication with the control means communication link.

14. The optical sensor feedback control device of claim 13, wherein the optical processor position adjustment device is selected from the group consisting of a stepper motor, a pneumatic piston, a hydraulically driven piston, an electric motor and a mechanical motor.

15. A method of feedback control of an optical sensor comprising:
(a) sinusoidally photoexciting a luminescent sensing film positioned adjacent a testing environment to create a luminescent emission within said film;
(b) detecting said luminescent emission and converting said luminescent emission signal to an electrical signal via a photodetector,
(c) determining the magnitude of the electrical signal via a control means;
(d) determining the phase of the electrical signal via a phase detector;
(e) controlling the magnitude of the sinusoidal photoexcitation of the sensing film based on the magnitude of the electrical signal determined by the control means; and
(f) converting the phase of the electrical signal to a parameter of interest value.

16. The method of feedback control of an optical sensor of claim 15, wherein the sinusoidal excitement of the sensing film comprises photoexcitation of the luminescent sensing film using an LED, organic LED, incandescent bulb, flashlamp, and/or electroluminescent display.

17. The method of feedback control of an optical sensor of claim 15, wherein the luminescent emission is converted to an electrical signal via a silicon photodiode, an avalanche photodiode or a photomultiplier tube.

18. The method of feedback control of an optical sensor of claim 15, wherein determination of the magnitude of the electrical signal via the control means is carried out using analog or digital methods.

19. The method of feedback control of an optical sensor of claim 15, wherein the sinusoidal excitement of the sensing film comprises photoexciting the luminescent sensing film using an LED, organic LED, incandescent bulb, flashlamp, or electroluminescent display via a fiber optic.
